(19) United States
(12) Patent Application Publication
(10) Pub. No.: US 2023/0075768 A1
(43) Pub. Date: Mar. 9, 2023

(54) DRIVE CONTROL DEVICE, DRIVE CONTROL METHOD FOR ELECTRIC VEHICLE, AND NON-TRANSITORY COMPUTER READABLE STORAGE MEDIUM STORING PROGRAM

(71) Applicant: KAWASAKI MOTORS, LTD., Akashi-shi (JP)

(72) Inventors: Eisaku KITAGAWA, Akashi-shi (JP); Kousuke NAKAYAMA, Akashi-shi (JP); Ryohei YOSHIDA, Akashi-shi (JP)

(21) Appl. No.: 17/929,989

(22) Filed: Sep. 6, 2022

(30) Foreign Application Priority Data
Sep. 6, 2021 (JP) 2021-145008

(51) Int. Cl. B60L 58/16; B60L 58/13

(52) U.S. Cl. CPC B60L 58/16; B60L 58/13

(57) ABSTRACT

There are provided a drive control device, a drive control method, and a non-transitory computer readable storage medium storing a program that control driving of an electric vehicle includes: a map storage unit storing a plurality of battery correlation maps, the battery correlation maps corresponding to a plurality of battery deterioration states and defining a relationship of a charge state and a battery temperature with an internal resistance of a battery; a map selection unit configured to select one battery correlation map from among the plurality of battery correlation maps stored in the map storage unit based on a current deterioration state of the battery; and a motor output control unit configured to control an output of a vehicular electric motor driven by the battery based on the one battery correlation map selected by the map selection unit.

### CROSS-REFERENCE TO RELATED APPLICATIONS

This application is based on and claims priority under 35 USC 119 from Japanese Patent Application No. 2021-145008 filed on Sep. 6, 2021, the contents of which are incorporated herein by reference.

### TECHNICAL FIELD

The present disclosure relates to a drive control device, a drive control method, a non-transitory computer readable storage medium storing a program that control driving of an electric vehicle.

### BACKGROUND ART

An electric vehicle equipped with a battery (secondary battery) and driven by electric power stored in the battery is disclosed (see, for example, JP2020-080591A). In the electric vehicle disclosed in JP2020-080591A, a torque command value of a motor is calculated in accordance with an accelerator operation and a motor output torque.

However, depending on a vehicle state, it may not be sufficient to calculate a torque command only based on an accelerator operation amount and a motor output torque.

### SUMMARY OF INVENTION

The present disclosure relates to drive control of an electric vehicle based on a vehicle state.

According to an illustrative aspect of the present disclosure, a drive control device configured to control driving of an electric vehicle includes: a map storage unit storing a plurality of battery correlation maps, the battery correlation maps corresponding to a plurality of battery deterioration states and defining a relationship of a charge state and a battery temperature with an internal resistance of a battery; a map selection unit configured to select one battery correlation map from among the plurality of battery correlation maps stored in the map storage unit based on a current deterioration state of the battery; and a motor output control unit configured to control an output of a vehicular electric motor driven by the battery based on the one battery correlation map selected by the map selection unit.

According to another illustrative aspect of the present disclosure, a drive control method for controlling driving of an electric vehicle includes: storing a plurality of battery correlation maps corresponding to a plurality of battery deterioration states and defining a relationship of a charge state and a battery temperature with an internal resistance of a battery; selecting one battery correlation map from among the plurality of battery correlation maps stored in the map storage unit based on a current deterioration state of the battery; and controlling an output of a vehicular electric motor driven by the battery based on the one battery correlation map selected by the map selection unit.

According to another illustrative aspect of the present disclosure, a non-transitory computer readable storage medium stores a program causing a computer to execute a drive control process of an electric vehicle, in which the drive control process includes: storing a plurality of battery correlation maps corresponding to a plurality of battery deterioration states and defining a relationship of a charge state and a battery temperature with an internal resistance of a battery; selecting one battery correlation map from among the plurality of battery correlation maps stored in the map storage unit based on a current deterioration state of the battery; and controlling an output of a vehicular electric motor driven by the battery based on the one battery correlation map selected by the map selection unit.

According to the drive control device, the drive control method for an electric vehicle, and the non-transitory computer readable storage medium storing the program of the present disclosure, the drive control of the electric vehicle can be performed corresponding to a deterioration state, a battery temperature, and a charge state of the battery, and more appropriate drive control can be realized according to a vehicle situation. For example, it is possible to estimate a maximum output torque that can be output for each situation, and it is possible to realize the drive control in consideration of the maximum output torque.

### BRIEF DESCRIPTION OF DRAWINGS

FIG. 1 is a block diagram illustrating a drive control device and an electric vehicle to which the drive control device is applied according to an embodiment of the present disclosure.

FIG. 2 is a block diagram illustrating a schematic configuration of the drive control device in FIG. 1.

FIG. 3 is a schematic diagram illustrating an example of a battery correlation map to be used in the drive control device in FIG. 2.

FIG. 4 is a flowchart illustrating an example of a drive control method to be executed by the drive control device in FIG. 2.

FIG. 5 is a schematic diagram illustrating an example of an estimation process performed by a deterioration state estimation unit of the drive control device in FIG. 2.

FIG. 6 is a schematic diagram illustrating an example of a calculation process of a charging internal resistance value performed by the deterioration state estimation unit of the drive control device in FIG. 2.

### DESCRIPTION OF EMBODIMENTS

Hereinafter, an embodiment according to the present disclosure will be described with reference to the drawings, but the present disclosure is not limited to the embodiment.

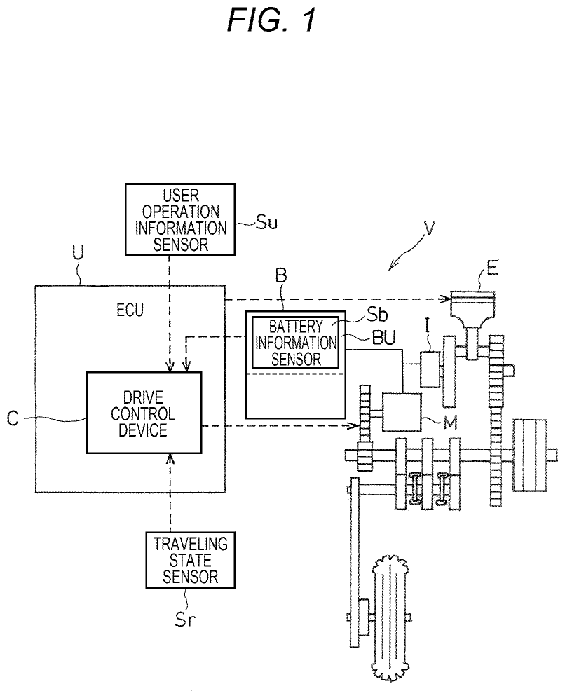

FIG. 1 illustrates a drive control device C for an electric vehicle according to an embodiment of the present disclosure (hereinafter, simply referred to as the “drive control device”) and an electric vehicle V to which the drive control device C is applied. According to the present embodiment, the electric vehicle V is configured as a hybrid type motorcycle. That is, the electric vehicle V according to the present embodiment includes a vehicle driving electric motor M, a battery B that drives the electric motor M, and an engine E. In the present specification, the term “battery” refers to a secondary battery that can electrochemically store electric power and can be repeatedly charged and discharged. In the present specification, the term “engine” refers to an internal combustion engine such as a four-cycle engine. In this example, the electric vehicle V is a parallel-type hybrid vehicle, and the engine E is used as a running drive source for the electric vehicle V and a charging drive source for the battery B. The electric vehicle V according to the present embodiment includes an electronic control unit (ECU) U that controls the entire electric vehicle V. The drive control device C is provided in the electronic control unit U.

For example, the drive control device C may be a controller that gives an output command value to the electric motor M by reading out a motor control program stored in advance by the electronic control unit and executing the motor control program. As described above, according to the present embodiment, the electronic control unit also functions as a controller that gives an output command to the electric motor M. The controller includes a processor that is a processing circuit, a memory that is a storage unit, and an interface that is an input and output device. The memory stores a program that calculates a command value for motor driving and parameters for calculation. The interface includes an input circuit to which a sensor output necessary for determining a drive command is input. Similarly, the interface includes an output circuit for outputting the drive command.

The electronic control unit according to the present embodiment has a function of outputting a command value for engine control. An existing technique can be applied to the engine control. For example, an engine output torque corresponding to an accelerator operation is calculated, and a control command value of an engine actuator (a throttle valve, a fuel injection valve, or an ignition plug) is output in order to obtain the output torque. The electronic control unit reads a program for engine control stored in the memory, and gives a control command to the actuator by executing the program by the processing circuit. However, the drive control device (controller) that drives the electric motor M may be provided separately from the electronic control unit that controls the engine E.

In the electric vehicle V (motorcycle) according to the present embodiment, as a hybrid mode, both the engine E and the electric motor M can be used as running drive sources. In the hybrid mode, the electronic control unit can adjust a power distribution between the engine E and the electric motor M so as to satisfy an operation by a user or a predetermined distribution condition.

In the electric vehicle V according to the present embodiment, the battery B is charged by power generation during vehicle driving. Specifically, the electric motor M and an inverter I that controls the electric motor M are configured as a generator with a motor function (ISG), and it is possible to extract a part of an output of the engine E to generate electric power when the vehicle is running only by the engine E and when the engine E is idling during operating, and it is possible to generate electric power by a regenerative brake when decelerating.

The electric vehicle V according to the present embodiment can be driven only by power of the electric motor M by disengaging a clutch, and can be driven by the engine E and the electric motor M by engaging the clutch. When driving of the electric motor M is stopped (idled) in a state where the clutch is engaged, a running drive only by the engine E is performed.

The drive control device C is a device that controls the motor driving of the electric vehicle V. The drive control device C generates a command value for the motor driving when a running state by the motor driving is selected by a separate program or a user operation. For example, the command value is generated such that an output torque corresponding to an accelerator operation amount given from an accelerator operation sensor is obtained. In addition, the command value is corrected and output so as to conform to a feeling of the user in accordance with, for example, changes over time in a running speed, a speed ratio, and the accelerator operation amount.

The drive control device C according to the present embodiment estimates a maximum output that can be output in accordance with an increase in internal resistance caused by an aged deterioration, a use temperature, and a battery charge state. A motor driving command value is generated based on the estimated maximum output. For example, even when a command that exceeds the maximum output of the motor is given as the user operation, a motor command value is generated so as not to exceed the maximum output. For example, during hybrid running, a distribution may be changed so as to increase an output distribution of the engine by an amount that the motor cannot output due to deterioration.

The electric vehicle V is provided with various sensors such as a user operation information sensor Su, a running state sensor Sr, and a battery information sensor Sb. These sensors are connected to the drive control device C, and information necessary for the drive control is input from these sensors. The user operation information sensor Su is, for example, an accelerator operation sensor, a brake sensor, or an HV/HEV mode switching sensor. The running state sensor Sr is, for example, a vehicle speed sensor, a gear ratio sensor, an input shaft rotation speed sensor, a clutch state sensor, or a clock. The battery information sensor Sb is, for example, a voltage sensor, a current sensor, or a temperature sensor.

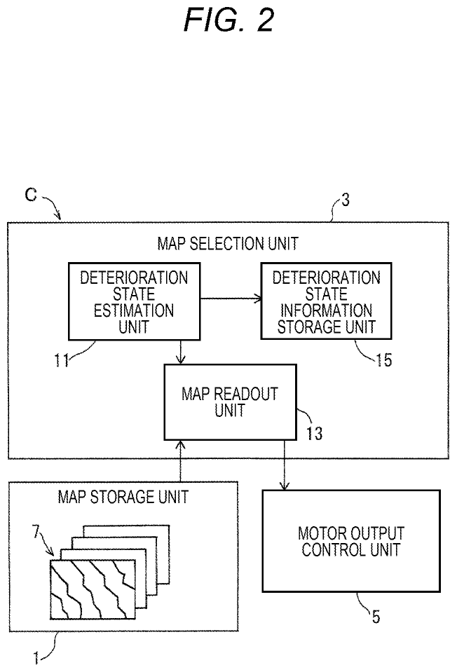

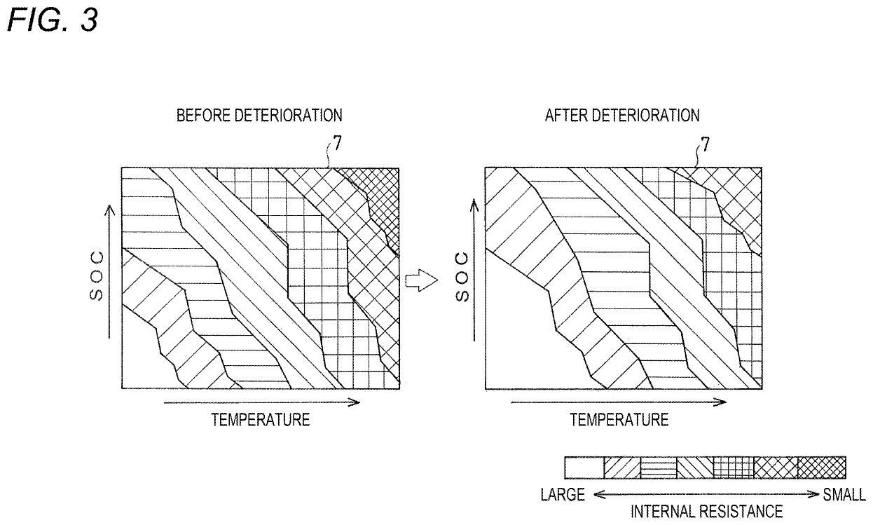

As illustrated in FIG. 2, the drive control device C includes a map storage unit 1, a map selection unit 3, and a motor output control unit 5. In the map storage unit 1, a plurality of battery correlation maps 7 are stored in advance in the memory. As exemplified in FIG. 3, the term “battery correlation map” in the present specification means a map that defines a correlation of a charge state (hereinafter, may be referred to as the “SOC”) and a battery temperature in a predetermined range of the battery B with an internal resistance value of the battery B. The charge state SOC is expressed as a charge ratio indicating a dischargeable amount, and is expressed as a charge ratio in which a fully charged state is 100% and a fully discharged state is 0%.

As illustrated in FIG. 3, in the battery correlation map 7, when comparison is made in the same SOC, the internal resistance tends to decrease (the output tends to increase) as the temperature increases. In addition, in the battery correlation map 7, when comparison is made at the same temperature, the internal resistance tends to decrease (the output tends to increase) as the SOC increases. As deterioration of the battery B progresses, the internal resistance tends to increase (the output tends to decrease) even in the same SOC and at the same temperature. Therefore, a plurality of battery correlation maps 7 corresponding to respective deterioration states are prepared. As a factor of such an increase in internal resistance, as will be described later, an aged deterioration in which a change is generated in accordance with an environmental temperature and a cycle deterioration in which a change is generated in accordance with repetition of charging and discharging are assumed. According to the present embodiment, the battery correlation maps 7 for the respective deterioration states are prepared in consideration of both the aged deterioration and the cycle deterioration. As the internal resistance increases, the maximum output that can be output by the battery B decreases.

The battery correlation map 7 illustrated in FIG. 3 is an example of a display format of the battery correlation map 7, and the battery correlation map 7 may be displayed in another format such as a table or a mathematical expression as long as the above-mentioned correlation is defined. That is, as long as the battery correlation map 7 indicates a relationship in which the battery output is obtained for each of three parameters of the battery temperature, the SOC, and the deterioration state. In the map storage unit 1 illustrated in FIG. 2, a plurality of battery correlation maps 7 corresponding to a plurality of battery deterioration states are each stored in advance.

The term “deterioration” of the battery B means deterioration caused by an increase in the internal resistance of the battery B. For example, when the internal resistance of the battery increases, the maximum output that can be output from the battery B decreases accordingly. As illustrated in FIG. 3, when the battery deteriorates, a region where the output is small (the internal resistance is large) is widened.

The term “battery temperature” means a temperature of a part of the battery B or a temperature around the battery B, which affects the output of the battery B. According to the present embodiment, a surface temperature of the battery to be detected by the sensor is used. However, in addition to the surface temperature of the battery, the battery temperature may be a temperature inside a battery pack. In addition, the battery temperature may be a directly measured value, or may be a value estimated based on a vehicle ambient temperature and a battery current amount.

First, an example of a procedure of preparing the battery correlation maps 7 will be described. In this example, a lithium ion secondary battery is used as the battery B. In the lithium ion secondary battery, a lithium-containing metal oxide is used as a positive electrode active material, a material (for example, carbon) capable of absorbing and extracting lithium ions is used as a negative electrode active material, and a nonaqueous solvent is used as an electrolytic solution.

In the case of the lithium ion secondary battery according to the present embodiment, it is considered that the deterioration of the battery B generally occurs due to main factors such as an electrode repeating to expand and contract by repeating a charge and discharge cycle, and a coating film being formed on a surface of the electrode by reaction between an electrode material and the electrolytic solution due to storage. Therefore, according to the present embodiment, the battery correlation maps 7 are prepared in which deterioration due to the former factor (hereinafter, referred to as the “cycle deterioration”) and deterioration due to the latter factor (hereinafter, referred to as the “calendar deterioration”) are considered in combination.

For example, in the cycle deterioration, standard charge and discharge cycle conditions and the number of charge and discharge cycles for each predetermined period (for example, one year) are derived from an assumed standard use pattern of the vehicle, and a charge and discharge cycle test is performed in accordance with the conditions and the number. In the charge and discharge cycle test, a battery temperature range and an SOC range in an assumed use environment of the vehicle are estimated, and the charge and discharge cycle test is performed for a plurality of values of the battery temperature and the SOC within these ranges. In this way, a plurality of batteries B in a cycle deterioration state are prepared.

In the calendar deterioration, the battery temperature range and the SOC range in the assumed use environment of the vehicle are estimated, and a storage test is performed for a plurality of values of the battery temperature and the SOC within these ranges. The storage test may be performed for an assumed actual use period, but since it is not actual to perform the test for a long period of time of several years, for example, a storage deterioration state for the assumed actual use period is reproduced in a simulated manner based on test results for several months by using a generally known storage deterioration estimation model.

The internal resistance of each battery B prepared as described above is measured. According to the present embodiment, the measurement of the internal resistance in a process of creating the battery correlation map 7 is performed in a standard state of the SOC and the battery temperature, which will be described later.

By adding the cycle deterioration and a storage deterioration for each predetermined period (for example, one year) measured as described above, a plurality of battery correlation maps 7 corresponding to the deterioration state of the battery B are prepared and stored in the map storage unit 1. A method of preparing the battery correlation maps 7 is not limited to the example described above, and can be appropriately selected in consideration of the type of the battery B to be used, the type, application, and use area of the electric vehicle V to be mounted, and main deterioration factors of the battery B. For example, in the above-mentioned example, the calendar deterioration and the cycle deterioration are used as parameters of a battery deterioration, but only one of the calendar deterioration and the cycle deterioration may be used. In addition, another value may be used as the parameter of the deterioration. For example, if the internal resistance measured in the past can be recognized, the parameter of the deterioration may be set based on an internal resistance measurement value thereof.

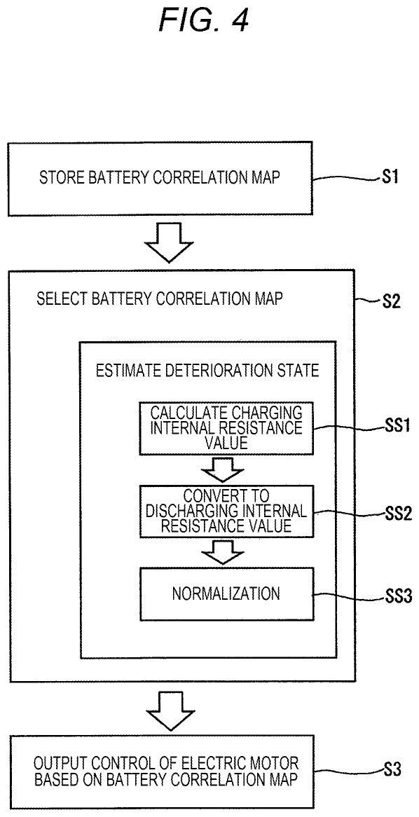

The plurality of battery correlation maps 7 prepared as described above are stored in the map storage unit 1 (step S1 in FIG. 4). The storage of the battery correlation maps 7 is not limited to before the use of the electric vehicle V, and the battery correlation maps 7 may be stored in a stepwise manner after the use is started, in accordance with a use situation of the electric vehicle V, the state of the battery B, and the like. For example, the use situation by each user may be detected, and the battery correlation map 7 suitable for the use situation may be stored after the use. The map selection unit 3 illustrated in FIG. 2 selects one battery correlation map 7 from the plurality of battery correlation maps 7 in the map storage unit 1 based on a current deterioration state of the battery B (step S2 in FIG. 4).

The map selection unit 3 according to the present embodiment includes a deterioration state estimation unit 11 that estimates the deterioration state. The deterioration state estimation unit 11 calculates a charging internal resistance value (which may be called as an internal resistance value at charging) of the battery B based on a charge characteristic measurement value of the battery B during vehicle driving (substep SS1 in FIG. 4), and estimates the deterioration state based on the charging internal resistance value.

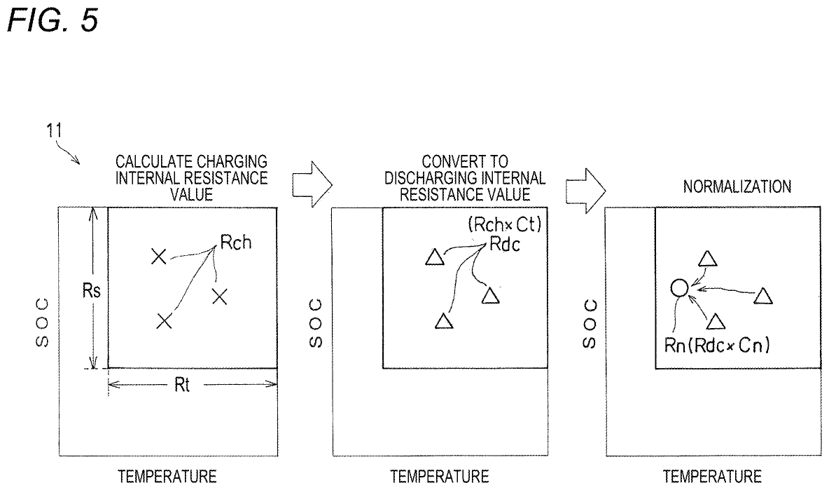

Specifically, as illustrated in FIG. 5, the deterioration state estimation unit 11 calculates a discharging internal resistance value (which may be called as an internal resistance value at discharging) Rdc of the battery B by multiplying a charging internal resistance value Rch by a predetermined conversion coefficient Ct (substep SS2 in FIG. 4). The conversion coefficient Ct is a conversion coefficient (or a conversion formula) for converting the charging internal resistance into the discharging internal resistance value Rdc, and can be obtained by measuring the battery B in advance.

Next, a normalized discharging internal resistance value Rn is calculated by multiplying the discharging internal resistance value Rdc by a normalization coefficient Cn for converting the charging internal resistance value into a predetermined discharging internal resistance value Rdc in the usage state of the battery B (substep SS3 in FIG. 4), and the deterioration state is estimated based on the normalized discharging internal resistance value Rn.

First, a method of calculating the charging internal resistance value Rch of the battery B based on the charge characteristic measurement value of the battery B during vehicle driving will be described. In the present embodiment, charge characteristic measurement of the battery B is performed by a battery management unit BU (FIG. 1) provided in the battery B.

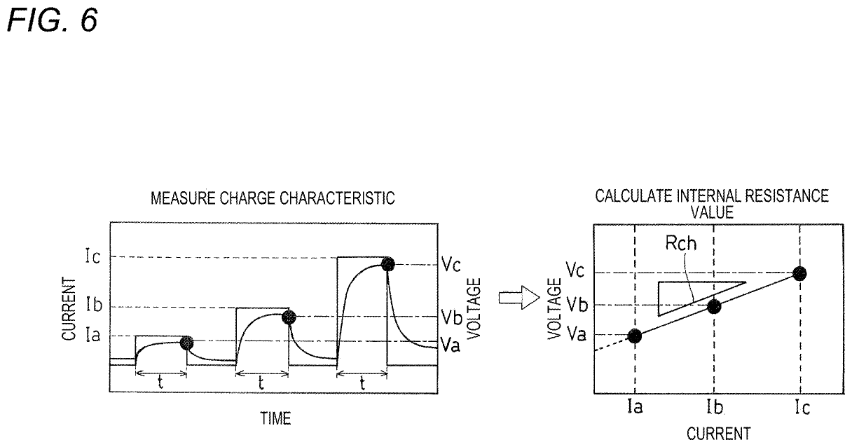

According to the present embodiment, as illustrated in FIG. 6, constant current charging of the battery B is performed for a predetermined charging time t at a plurality of different charge current values (three current values Ia, Ib, and Ic in the illustrated example) at the battery temperature within a predetermined range and in the SOC within the predetermined range during vehicle driving, and the current values Ia, Ib, and Ic at the time of charging and voltage values Va, Vb, and Vc of the battery B after the charging are measured. The charging time t is, for example, 5 seconds. In addition, after charging at each current value, the charging is stopped for a predetermined time (for example, 5 seconds) or more. Next, the voltage values Va, Vb, and Vc corresponding to the measured charging current values Ia, Ib, and Ic are plotted as illustrated in the same figure, and a slope (ΔV/ΔI) of a change amount (ΔV) of the voltage value with respect to a change amount (ΔI) of the charge current value is calculated by linear approximation, and this slope is set as the charging internal resistance value Rch of the battery B. According to the present embodiment, as illustrated in FIG. 5, the charging internal resistance value Rch is measured at a plurality of points within a predetermined battery temperature range and a predetermined SOC range, which will be described later.

The charge current value for calculating the above-described charging internal resistance value Rch and the number of points of the charge current value (three points of Ia, Ib, and Ic in the above-described example) are merely examples, and the charging internal resistance value Rch may be calculated by current values different from the charge current value and a plurality of points (for example, two points) of the current values. In addition, the charging internal resistance value Rch may be calculated based on the charge current value and the voltage value at only one point and a voltage value (open circuit voltage value) after the charging is stopped thereafter. However, by using values measured at a plurality of points as illustrated, the resistance value can be calculated with higher accuracy.

According to the present embodiment, the deterioration state estimation unit 11 starts to acquire the charging internal resistance value Rch when a predetermined condition is satisfied. Specifically, the deterioration state estimation unit 11 calculates the charging internal resistance value Rch of the battery B based on the charge characteristic measurement value of the battery B in a stable driving state. Here, the term “stable driving state” refers to a predetermined driving state of the vehicle in which a fluctuation range of the charge current value is assumed to be within a predetermined range. Specifically, the stable driving state is, for example, a state where a change in the running speed (engine speed) is equal to or less than a predetermined value, a state where a shift operation is not performed, or a state where a vehicle body bank angle is equal to or less than a predetermined value when the electric vehicle V is running with engine driving. Further, a state where the engine E is idling is also included in the stable driving state.

According to the present embodiment, as illustrated in FIG. 5, the deterioration state estimation unit 11 performs the charge characteristic measurement for calculating the charging internal resistance value Rch in a state where the battery temperature is within a predetermined temperature range Rt. Specifically, the predetermined temperature range Rt is preferably 5° C. or higher, more preferably 15° C. or higher, and still more preferably 25° C. or higher. The predetermined temperature range Rt is preferably, for example, 60° C. or lower.

In addition, according to the present embodiment, the deterioration state estimation unit 11 (FIG. 2) performs the charge characteristic measurement for calculating the charging internal resistance value in a state where the SOC is within a predetermined range Rs. Specifically, the predetermined range Rs is preferably 10% or more, more preferably 20% or more, and still more preferably 30% or more.

Next, a procedure of calculating the discharging internal resistance value Rdc of the battery B by multiplying the charging internal resistance value Rch by the predetermined conversion coefficient Ct will be described. According to the present embodiment, a relationship (magnification) between the charging internal resistance value Rch and a corresponding discharging internal resistance value (hereinafter, simply referred to as the “discharging internal resistance value Rdc”) is obtained in advance, and is determined as a charge and discharge conversion coefficient Ct. The deterioration state estimation unit 11 calculates the discharging internal resistance value Rdc by multiplying the charging internal resistance value Rch by the charge and discharge conversion coefficient Ct determined as described above.

That is, as described above, the deterioration state estimation unit 11 calculates the discharging internal resistance value Rdc corresponding to a specific SOC and battery temperature when the charging internal resistance value Rch is measured. As described above, since the deterioration state estimation unit 11 calculates the discharging internal resistance value Rdc using the SOC and the battery temperature at the time of the charge characteristic measurement of the battery B, the charging internal resistance value Rch and the discharging internal resistance value Rdc are appropriately associated with each other, and the deterioration estimation can be performed with high accuracy.

The charge and discharge conversion coefficient Ct may be set to a single coefficient for the entire range of the battery temperature and the SOC in which the charge characteristic measurement is assumed to be performed, or may be set to different coefficients for each predetermined range of the battery temperature and the SOC.

Next, a procedure of calculating the normalized discharging internal resistance value Rn by multiplying the discharging internal resistance value Rdc by the normalization coefficient Cn for converting the charging internal resistance value into a predetermined discharge resistance value in the usage state of the battery B (hereinafter, simply referred to as the “normalization”) will be described. According to the present embodiment, specifically, a standard state of the battery B is determined in advance as the above-mentioned usage state. Here, the term “standard state” means an assumed standard usage state of the battery B. Specifically, the standard state is set to a predetermined single state for deterioration evaluation. Specifically, the standard state is a state defined by the battery temperature and the SOC, and is, for example, a state where the battery temperature is 25° C. and the SOC is 80%. As a result, it is possible to prevent a deterioration evaluation variation due to variations in the battery temperature and the SOC.

According to the present embodiment, a normalized map is prepared in advance and stored in the deterioration state estimation unit 11. In the normalized map, a correspondence relationship between each of the discharging internal resistance values Rdc at various battery temperatures and SOCs and the discharging internal resistance value in the standard state is defined by actual measurement of the battery B. The deterioration state estimation unit 11 calculates the normalized discharging internal resistance value Rn by multiplying by the normalization coefficient Cn according to the normalized map. The normalized map may be prepared as a conversion formula.

Thereafter, a map readout unit 13 of the map selection unit 3 illustrated in FIG. 2 compares the normalized discharging internal resistance value Rn with the internal resistance value in the standard state in each map of the plurality of battery correlation maps 7, and selects one battery correlation map 7 having a standard state internal resistance value closest to the normalized discharging internal resistance value as one battery correlation map 7 to be used for vehicle drive control to be described later.

As described above, according to the present embodiment, when the drive control of the electric vehicle V, that is, an output control of the electric motor M is performed, the internal resistance value of the battery B is measured based on the charge characteristic. In the hybrid electric vehicle, for example, motor driving is likely to be used in a low speed running region in which an acceleration and deceleration frequency is high, and engine driving is likely to be used in a high speed running region in which the acceleration and deceleration frequency is low. Therefore, in general, a current flowing through the battery is likely to be stable at the time of charging. For this reason, even during vehicle driving, it is easier to measure a stable value by selecting a situation in which a fluctuation of the current value is small in measuring a charge characteristic, as compared with a case of measuring a discharge characteristic. Therefore, the deterioration state can be estimated with a high accuracy, and the accuracy of estimating the maximum output of the battery can be improved. Accordingly, the accuracy of the drive control according to the maximum output of the battery can be improved. For example, an output command equal to or greater than the maximum output is prevented from being given. In addition, for example, it is possible to prevent a margin from becoming excessive and to output the maximum output corresponding to a battery capacity. In addition, for example, it is possible to increase an output distribution of the engine so as to compensate for the battery output decreased due to the deterioration.

In particular, as described above, when the charging internal resistance value Rch of the battery B is calculated based on the charge characteristic measurement value of the battery B in the stable driving state, the internal resistance value of the battery B is measured based on the charge characteristic in a state where the fluctuation range of the current value is particularly small and the stable value can be measured. Therefore, the deterioration state can be estimated with higher accuracy.

As described above, the deterioration state estimation unit 11 calculates the discharging internal resistance value Rdc of the battery B by multiplying the charging internal resistance value Rch by the predetermined conversion coefficient Ct, and estimates the deterioration state based on the discharging internal resistance value Rdc. As described above, by a simple process of multiplying by the predetermined conversion coefficient Ct, the deterioration state is estimated based on the internal resistance value at the time of discharging close to the condition under which the battery correlation map 7 is acquired. Therefore, the estimation can be efficiently performed with high accuracy.

In the present embodiment, the deterioration state estimation unit 11 calculates the normalized discharging internal resistance value Rn by multiplying the discharging internal resistance value Rdc by the normalization coefficient Cn for converting the charging internal resistance value into the discharging internal resistance value Rdc in the assumed standard usage state of the battery B, and estimates the deterioration state based on the normalized discharging internal resistance value Rn. According to the configuration, by normalizing the discharging internal resistance values Rdc calculated as values under different states (SOC and cell temperature) to values under a standard condition, comparison with the plurality of prepared battery correlation maps 7 can be performed with high accuracy. Accordingly, the drive control can be performed with higher accuracy.

However, in the drive control device C according to the present disclosure, it is not essential to calculate the charging internal resistance value Rch of the battery B based on the charge characteristic measurement value of the battery B during vehicle driving and estimate the deterioration state based on the charging internal resistance value Rch. That is, one battery correlation map 7 to be used for the drive control may be selected from the plurality of battery correlation maps 7 based on the deterioration state estimated by another method such as estimating the deterioration state of the battery B based on a discharge characteristic measurement value of the battery B.

In addition, even when the deterioration state is estimated based on the charging internal resistance value Rch, it is not essential to calculate, after the charging internal resistance value Rch is acquired, the discharging internal resistance value Rdc and the normalized discharging internal resistance value. That is, for example, the battery correlation map 7 may be selected without calculating the discharging internal resistance value Rdc by determining a rule for directly selecting the battery correlation map 7 based on the charging internal resistance value Rch.

In addition, the procedure for estimating the deterioration of the battery may be different from the procedure exemplified in the present embodiment. For example, according to the present embodiment, the charging internal resistance value Rch is converted into the discharging internal resistance value Rdc and then normalized, but the charging internal resistance value Rch may be normalized and then converted into the discharging internal resistance value Rdc. According to the present embodiment, the conversion into the discharging internal resistance value Rdc and the normalization of the discharging internal resistance value Rdc are performed in two steps, but may be performed in one step. That is, the acquired charging internal resistance value Rch may be converted into the discharging internal resistance value Rdc in the standard state of the battery within one step.

According to the present embodiment, the map selection unit 3 includes a deterioration state information storage unit 15 capable of storing information on the above-mentioned deterioration state estimated by the deterioration state estimation unit 11 until a next deterioration state estimation. In other words, the expression “capable of storing . . . until a next deterioration state estimation” here means that the information can be continuously stored even after the power supply to the drive control device C is cut off. In addition, the “information on the deterioration state” here includes information on the deterioration state of the battery B which is directly required at least for selecting the battery correlation map 7. For example, when the battery correlation map 7 is selected using the normalized discharging internal resistance value Rn as described as the present embodiment, at least the latest normalized discharging internal resistance value Rn is stored in the deterioration state information storage unit 15 at least until the next deterioration state estimation is performed. Here, the deterioration state information storage unit 15 may be realized by a memory as a storage unit.

Since the deterioration of the battery B does not rapidly progress, an update of the battery correlation map 7 does not necessarily have to be performed from the start to the end of the driving of the electric vehicle V. As described above, since the map selection unit 3 includes the deterioration state information storage unit 15 and the information on the deterioration state can be continuously held even after the power supply to the drive control device C is cut off, it is not necessary to perform the deterioration state estimation every time the power supply is newly started. Therefore, since the information on the deterioration state acquired in a situation where the deterioration state can be estimated with high accuracy as described above can be continuously used, it is possible to prevent the accuracy of the deterioration estimation from being lowered.

The motor output control unit 5 controls the output of the vehicle driving electric motor M driven by the battery B based on the battery correlation map 7 selected by the map readout unit 13 of the map selection unit 3 (step 3 in FIG. 4). Specifically, the output of the electric motor M is controlled by converting the internal resistance value (in this example, the normalized discharging internal resistance value Rn) of the battery B into the maximum output value of the battery B and limiting the output of the battery B so as to be equal to or less than the maximum output value. An upper limit value of the output of the electric motor M may be recognized by the driver by, for example, meter display, voice output, or the like.

According to the present embodiment, the hybrid electric vehicle V including the electric motor M and the engine E has been described as an example of the electric vehicle V to be controlled illustrated in FIG. 1. In the present embodiment, the engine E included in the electric vehicle V is used for both driving of the vehicle and charging of the battery B, but the engine E may be used only for the charging of the battery B. In general, in the hybrid electric vehicle V, the battery B can be charged while the vehicle is running and the vehicle can be driven by the engine E. Therefore, a margin of an SOC region range of the battery B to be actually used is set to be small, and a necessity of an output control of the battery B is particularly high. With the drive control device C according to the present embodiment, a highly accurate output control can be performed according to the margin of the SOC region range in such a hybrid electric vehicle V.

In the case of a parallel-type hybrid vehicle such as the electric vehicle V according to the present embodiment, a hybrid battery is mainly used in order to assist the driving by the engine, so that a compact, lightweight, output-focused type battery is generally used. In addition, in the parallel-type hybrid vehicle V, since charging and discharging states are frequently switched according to acceleration and deceleration during running, an influence of the deterioration due to the repetition of the charging and discharging of the battery is large. Therefore, in the parallel-type hybrid vehicle, there is a great advantage of realizing the highly accurate output control by applying the drive control device C according to the present embodiment to the hybrid vehicle.

However, the electric vehicle V to be controlled may be of a hybrid type other than the parallel type, for example, a series hybrid type. The electric vehicle V to be controlled is not limited to the hybrid electric vehicle V as long as the electric vehicle V includes the electric motor M driven by the battery B as a drive source of the vehicle.

In addition, according to the present embodiment, as an example of the electric vehicle V to be controlled, a motorcycle which is an electric straddle-type vehicle has been described. However, the electric vehicle V to be controlled may be, for example, a straddle-type vehicle such as a buggy having three or more wheels other than the motorcycle. The straddle-type vehicle has a relatively small dimension in a vehicle width direction, is easily affected by the temperature of the vehicle body in the vehicle width direction, and has a battery B easily affected by an outside air temperature. Therefore, the highly accurate output control is desired. In such an electric straddle-type vehicle, by applying the drive control device according to the present embodiment, the highly accurate output control can be realized. However, the electric vehicle V to be controlled is not limited to the straddle-type vehicle.

In addition, according to the present embodiment, an example in which the drive control device C is provided in the electronic control unit U has been described, but the drive control device may be provided in another place in the electric vehicle V.

In addition, according to the present embodiment, the lithium ion secondary battery has been described as an example of the battery B, but other secondary batteries, for example, a nickel-hydrogen secondary battery, a nickel-cadmium secondary battery, and a lead storage battery, in which the capacity changes depending on repetition of charging and discharging, a temperature environment, a charge state, and a deterioration state, can also be applied.

According to the drive control device C and the drive control method of the electric vehicle V according to the present embodiment described above, it is possible to perform a highly accurate drive control corresponding to the deterioration state, the battery temperature, and the SOC of the battery B by using the plurality of battery correlation maps 7 corresponding to the different deterioration states of the battery B.

In the present embodiment, the map selection unit 3 illustrated in FIG. 2 may include the deterioration state estimation unit 11 that estimates the deterioration state, and the deterioration state estimation unit 11 may calculate the charging internal resistance value Rch of the battery B based on the charge characteristic measurement value of the battery B during vehicle driving, and estimate the deterioration state based on the charging internal resistance value Rch. According to the configuration, since the internal resistance value of the battery B is measured based on the charge characteristic in which the fluctuation of the current value is small and the stable value can be measured, it is possible to estimate the deterioration state with high accuracy. Accordingly, it is possible to realize the drive control with higher accuracy.

In the present embodiment, the deterioration state estimation unit 11 may calculate the discharging internal resistance value Rdc of the battery B by multiplying the charging internal resistance value Rch by the predetermined conversion coefficient Ct, and estimate the deterioration state based on the discharging internal resistance value Rdc. According to the configuration, as described above, by a simple process of multiplying by the predetermined conversion coefficient Ct, the deterioration state is estimated based on the internal resistance value at the time of discharging close to the condition under which the battery correlation map 7 is acquired. Therefore, the estimation can be efficiently performed with high accuracy.

In the present embodiment, the deterioration state estimation unit 11 may estimate the deterioration state using the charge state and the battery temperature at the time of the charge characteristic measurement of the battery B. According to the configuration, as described above, since the charging internal resistance value Rch and the discharging internal resistance value Rdc can be appropriately associated with each other, the deterioration estimation can be performed with high accuracy.

In the present embodiment, the deterioration state estimation unit 11 may calculate the normalized discharging internal resistance value Rn by multiplying the discharging internal resistance value Rdc by the normalization coefficient Cn for converting the charging internal resistance value into a predetermined discharge resistance value in the usage state of the battery B, and estimate the deterioration state based on the normalized discharging internal resistance value Rn. According to the configuration, as described above, by normalizing the discharging internal resistance values Rdc calculated as values under different states (SOC and cell temperature) to values under a certain condition, the comparison with the plurality of prepared battery correlation maps 7 can be performed with high accuracy. Accordingly, the drive control can be performed with higher accuracy.

In the present embodiment, the deterioration state estimation unit 11 may calculate the charging internal resistance value Rch of the battery B based on the charge characteristic measurement value of the battery B in a predetermined driving state of the vehicle in which the fluctuation range of the charge current value is assumed to be within a predetermined range. According to the configuration, as described above, since the internal resistance value of the battery B is measured based on the charge characteristic in a state where the fluctuation range of the current value is particularly small and the stable value can be measured. Therefore, the deterioration state can be estimated with higher accuracy.

In the present embodiment, the deterioration state estimation unit 11 may calculate the charging internal resistance value Rch of the battery B based on the charge characteristic measurement value of the battery B in a state where the battery temperature is within a predetermined temperature range. According to the configuration, as described above, since the charge characteristic value of the battery B in a specific temperature range in which the charge characteristic tends to be stabilized is used, a charging internal resistance value Rch with small variation can be obtained.

In the present embodiment, the map selection unit 3 may further include the deterioration state information storage unit 15 capable of storing the information on the deterioration state estimated by the deterioration state estimation unit 11 until the next deterioration state estimation. According to the configuration, as described above, it is not necessary to perform the deterioration state estimation every time the power supply is newly started. Therefore, since the information on the deterioration state acquired in a situation where the deterioration state can be estimated with high accuracy can be continuously used, it is possible to prevent the accuracy of the deterioration estimation from being lowered.

In the present embodiment, the electric vehicle V may be the hybrid electric vehicle V including the electric motor M and the engine E. According to the configuration, as described above, the margin of the SOC region range of the battery B to be actually used is set to be small, and it is possible to perform the highly accurate output control in the hybrid electric vehicle V in which the necessity of the output control of the battery B is particularly high.

In the present embodiment, the electric vehicle V may be the straddle-type vehicle. As described above, the straddle-type vehicle has a relatively small dimension in the vehicle width direction, is easily affected by the temperature of the vehicle body in the vehicle width direction, and has a battery B easily affected by an outside air temperature. In an electric straddle-type vehicle in which such a highly accurate output control is particularly desired, the highly accurate output control can be realized.

Although the preferred embodiments of the present disclosure have been described above with reference to the drawings, various additions, modifications, and deletions may be made without departing from the spirit of the present disclosure. Therefore, such examples are also included in the scope of the present disclosure.

What is claimed is:

1. A drive control device configured to control driving of an electric vehicle, the drive control device comprising:
a map storage unit storing a plurality of battery correlation maps, the battery correlation maps corresponding to a plurality of battery deterioration states and defining a relationship of a charge state and a battery temperature with an internal resistance of a battery;
a map selection unit configured to select one battery correlation map from among the plurality of battery correlation maps stored in the map storage unit based on a current deterioration state of the battery; and
a motor output control unit configured to control an output of a vehicular electric motor driven by the battery based on the one battery correlation map selected by the map selection unit.

2. The drive control device according to claim 1, wherein
the map selection unit includes a deterioration state estimation unit configured to estimate the deterioration state of the battery, and
the deterioration state estimation unit is configured to:
calculate an internal resistance value at charging of the battery from a charge characteristic measurement value of the battery during the electric vehicle running; and
estimate the deterioration state based on the internal resistance value at charging.

3. The drive control device according to claim 2, wherein
the deterioration state estimation unit is configured to:
calculate an internal resistance value at discharging of the battery by multiplying the internal resistance value at charging by a predetermined conversion coefficient; and
estimate the deterioration state based on the internal resistance value at discharging.

4. The drive control device according to claim 3, wherein
the deterioration state estimation unit is configured to estimate the deterioration state using the charge state and the battery temperature at a time of the charge characteristic measurement of the battery.

5. The drive control device according to claim 3, wherein
the deterioration state estimation unit is configured to:
calculate a normalized internal resistance value at discharging by multiplying the internal resistance value at discharging by a normalization coefficient for converting the internal resistance value at discharging into a discharge resistance value in a predetermined usage state of the battery; and
estimate the deterioration state based on the normalized internal resistance value at discharging.

6. The drive control device according to claim 2, wherein
the deterioration state estimation unit is configured to calculate the internal resistance value at charging of the battery from the charge characteristic measurement value of the battery in a predetermined running state of the electric vehicle where a fluctuation range of a charge current value is assumed to be within a predetermined range.

7. The drive control device according to claim 2, wherein
the deterioration state estimation unit is configured to calculate the internal resistance value at charging of the battery from the charge characteristic measurement value of the battery in a state where the battery temperature is within a predetermined temperature range.

8. The drive control device according to claim 2, wherein
the map selection unit further includes a deterioration state information storage unit capable of storing information on the deterioration state estimated by the deterioration state estimation unit until a next deterioration state estimation.

9. The drive control device according to claim 1, wherein
the electric vehicle is a hybrid electric vehicle including the electric motor and an engine.

10. The drive control device according to claim 1, wherein
the electric vehicle is a straddle-type vehicle.

11. A drive control method for controlling driving of an electric vehicle, the drive control method comprising:
storing a plurality of battery correlation maps corresponding to a plurality of battery deterioration states and defining a relationship of a charge state and a battery temperature with an internal resistance of a battery;
selecting one battery correlation map from among the plurality of battery correlation maps stored in the map storage unit based on a current deterioration state of the battery; and
controlling an output of a vehicular electric motor driven by the battery based on the one battery correlation map selected by the map selection unit.

12. A non-transitory computer readable storage medium storing a program causing a computer to execute a drive control process of an electric vehicle, the drive control process comprising:
storing a plurality of battery correlation maps corresponding to a plurality of battery deterioration states and defining a relationship of a charge state and a battery temperature with an internal resistance of a battery;
selecting one battery correlation map from among the plurality of battery correlation maps stored in the map storage unit based on a current deterioration state of the battery; and
controlling an output of a vehicular electric motor driven by the battery based on the one battery correlation map selected by the map selection unit.
